(19) United States
(12) Patent Application Publication
(10) Pub. No.: US 2020/0336447 A1
(43) Pub. Date: Oct. 22, 2020

(54) METHOD AND DEVICE FOR DISPLAYING REPLY MESSAGE

(71) Applicant: Alibaba Group Holding Limited, Grand Cayman (KY)

(72) Inventor: Guilong Hu, Hangzhou (CN)

(21) Appl. No.: 16/849,742

(22) Filed: Apr. 15, 2020

(30) Foreign Application Priority Data
Apr. 16, 2019 (CN) 201910304608.6

(51) Int. Cl. H04L 12/58; H04W 4/12; G06F 3/0482

(52) U.S. Cl. CPC H04L 51/066; H04L 51/16; H04L 51/08; G06F 3/0482; H04W 4/12

(57) ABSTRACT

A method including, receiving a reply instruction issued by a user for a part of the content of any first message shown in a conversation window; receiving a reply content input by the user for the part of the content; in response to an instruction to send the reply content, displaying a reply message in the conversation window. The reply message comprises at least a message reference portion and the reply content, and the message reference portion prompts, in a predetermined format, the part of the content targeted by the reply content.

### CROSS REFERENCE TO RELATED PATENT APPLICATIONS

This application claims priority to Chinese Patent Application No. 201910304608.6, filed on 16 Apr. 2019 and entitled “METHOD AND DEVICE FOR DISPLAYING REPLY MESSAGE,” which is incorporated herein by reference in its entirety.

### TECHNICAL FIELD

The present disclosure relates to the field of communication technologies, and, more particularly, to methods and devices for displaying a reply message.

### BACKGROUND

Instant messaging (IM) service allows multiple users to instantly exchange messages through respective terminals. The messages may include text messages, documents, audio and video files, and so on. At present, in order to allow users to have better communication, some instant messaging platforms provide their users with the ability to reply to the entire message.

However, the message reply function currently provided to users is too simple to meet various needs of the users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure describes methods and devices for displaying a reply message, so that a user may select a part of any message in a conversation window to reply to. A reply function is disclosed in the example embodiments of the present disclosure, so that when a user uses an instant messaging service, the user may reply to a part of the message, so as to enhance the pertinence of the reply message, thereby improving the user experience.

According to an example embodiment, a method for displaying a reply message is provided, wherein the method is executed by an instant messaging client, the method comprising: receiving a reply instruction issued by a user for a part of the content of any first message shown in a conversation window; receiving a reply content input by the user for the part of the content; and in response to an instruction to send the reply content, displaying a reply message in the conversation window, wherein the reply message comprises at least a message reference portion and the reply content, and the message reference portion prompts, in a predetermined format, the part of the content targeted by the reply content.

For example, the first message is a message received from a current contact corresponding to the conversation window.

For example, prior to the step of receiving a reply instruction issued by a user for a part of the content of any first message shown in a conversation window, the method further comprises: displaying a menu list comprising a reply menu item in response to the user's selection instruction for the part of the content on the basis of the first message; and the step of receiving a reply instruction issued by a user for a part of the content of any first message shown in a conversation window comprises: receiving a trigger instruction for the reply menu item.

For example, prior to the step of receiving a reply instruction issued by a user for a part of the content of any first message shown in a conversation window, the method further comprises: in response to a trigger instruction for the first message, displaying a menu list comprising a menu item for replying to the part of the content; receiving a trigger instruction for the menu item for replying to the part of the content; and the step of receiving a reply instruction issued by a user for a part of the content of any first message shown in a conversation window comprises: receiving a selection instruction for the part of the content in the first message.

For example, prior to the step of receiving a reply content input by the user for the part of the content, the method further comprises displaying prompt information in a conversation interface where the conversation window is located, wherein the prompt information comprises the message reference portion.

Further, for example, the conversation interface comprises an input box, the displaying prompt information in a conversation interface where the conversation window is located comprising displaying the prompt information above the input box or in the input box.

For example, the message reference portion includes only the part of the content.

For example, the part of the content corresponds to a plurality of sections of content in the first message; and the message reference portion comprises the plurality of sections of content separated and identified by a first preset separator.

For example, the message reference portion comprises the message content of the first message, wherein the part of the content is displayed with emphasis.

Further, for example, the display with emphasis comprises at least one selected from the group including a highlighted display, a color changing display, a bolded display and an underlined display.

For example, the reply message further comprises a second preset separator for separating the message reference portion from the reply content.

Further, for example, the message reference portion, the second preset separator and the reply content are combined into the reply message in an order of from left to right; or the message reference portion, the second preset separator and the reply content are combined into the reply message in an order of from top to bottom.

According to an example embodiment, a method for displaying a message is provided, wherein the method is executed by an instant messaging client, the method comprising: receiving a reply instruction issued by a user for a part of the content of any first message shown in a conversation window, wherein the first message is a message sent by the user; receiving a reply content input by the user for the part of the content; and in response to an instruction to send the reply content, displaying a reply message in the conversation window, wherein the reply message comprises at least a message reference portion and the reply content, and the message reference portion prompts, in a predetermined format, the part of the content targeted by the reply content.

According to an example embodiment, an instant messaging client is provided, which comprises: a display area for displaying a reply message generated in response to a sending instruction for a reply content in a conversation window, the reply content being input by a user for a part of the content in any first message shown in the conversation window, the reply message comprising at least the reply content and a message reference portion, wherein the message reference portion prompts, in a predetermined format, the part of the content targeted by the reply content.

According to an example embodiment, a device for displaying a reply message is provided, wherein the device is integrated with an instant messaging client, the device comprising: a first receiving unit, which is configured to receive a reply instruction issued by a user for a part of the content of any first message shown in a conversation window; a second receiving unit, which is configured to receive a reply content input by the user for the part of the content; and a display unit, which is configured to, in response to an instruction to send the reply content, display a reply message in the conversation window, wherein the reply message comprises at least a message reference portion and the reply content, and the message reference portion prompts, in a predetermined format, the part of the content targeted by the reply content.

According to an example embodiment, a computer readable storage medium having stored thereon a computer program or computer-executable instructions is provided; when the computer program or computer-readable instructions are executed by a computer, the computer is caused to execute the method embodiments.

According to a sixth example embodiment, a computing device is provided, which comprises one or more memories and processors, characterized in that the memories store computer-executable instructions, and when the processors execute the computer-executable instructions, the processors implement the method embodiments.

Through the methods for displaying a reply message provided in the example embodiments of the present disclosure, a user may select a part of any message in the conversation window to reply to.

### BRIEF DESCRIPTION OF DRAWINGS

In order to more clearly explain the technical solutions of the example embodiments disclosed in the present disclosure, the drawings for the description of the example embodiments will be briefly introduced below. Obviously, the drawings in the following description merely represent a few embodiments of the present disclosure. For a person of ordinary skill in the art, other drawings may be obtained on the basis of these drawings without creative efforts.

FIG. 1A is a first schematic diagram of the conversation interface disclosed in the example embodiments of the present disclosure.

FIG. 1B is a second schematic diagram of the conversation interface disclosed in the example embodiments of the present disclosure.

FIG. 2 is a flowchart of a method for displaying a reply message according to an example embodiment.

FIG. 3 is a third schematic diagram of the conversation interface disclosed in the example embodiments of the present disclosure.

FIG. 4A is a fourth schematic diagram of the conversation interface disclosed in the example embodiments of the present disclosure.

FIG. 4B is a fifth schematic diagram of the conversation interface disclosed in the example embodiments of the present disclosure.

FIG. 5 is a sixth schematic diagram of the conversation interface disclosed in the example embodiments of the present disclosure.

FIG. 6 is a seventh schematic diagram of the conversation interface disclosed in the example embodiments of the present disclosure.

FIG. 7 is an eighth schematic diagram of the conversation interface disclosed in the example embodiments of the present disclosure.

FIG. 8 is a ninth schematic diagram of the conversation interface disclosed in the example embodiments of the present disclosure.

FIG. 9 is a tenth schematic diagram of the conversation interface disclosed in the example embodiments of the present disclosure.

FIG. 10 is an eleventh schematic diagram of the conversation interface disclosed in the example embodiments of the present disclosure.

FIG. 11 is a structural diagram of a device for displaying a reply message according to an example embodiment.

### DETAILED DESCRIPTION

In reference to the accompanying drawings, the plurality of example embodiments disclosed in the present disclosure will be described in detail.

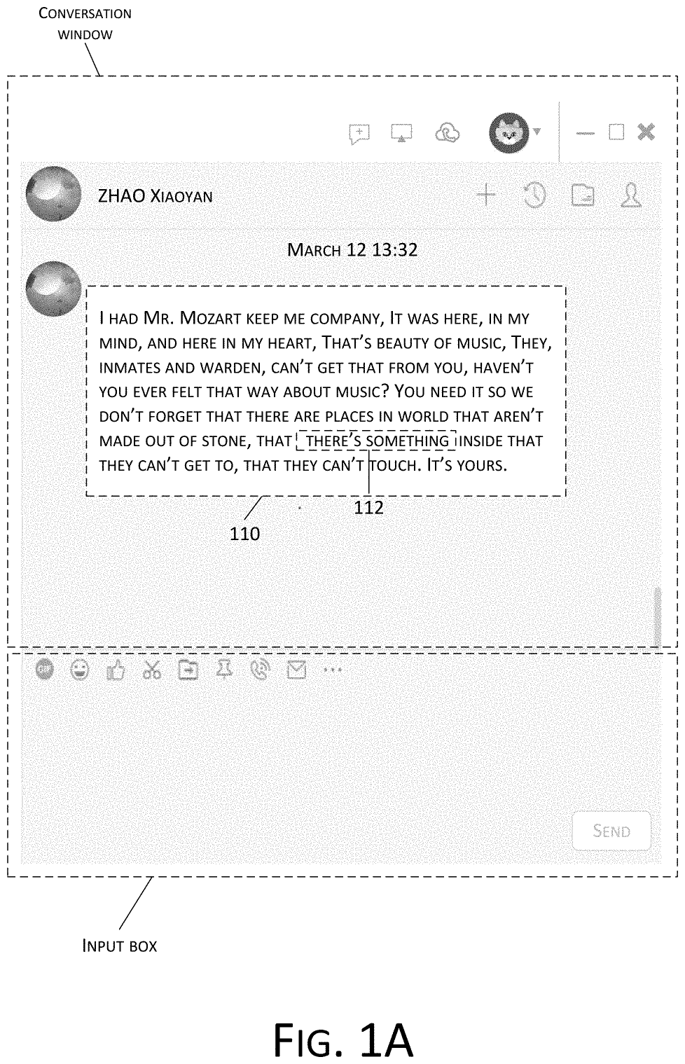

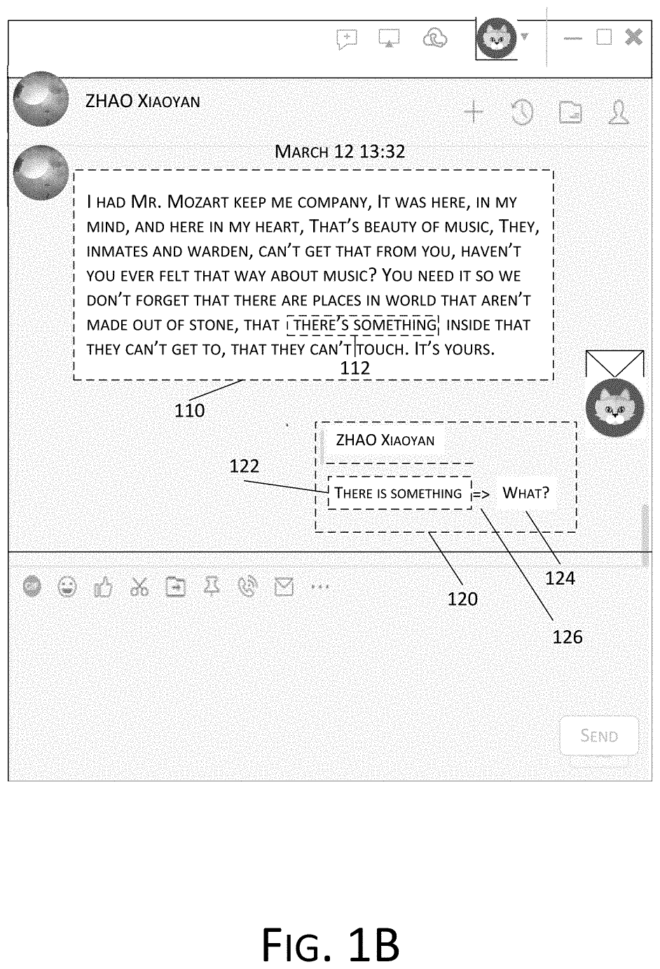

In IM chat, it is often necessary to respond to a message sent by a user. At present, some instant messaging software, such as Ding Talk, provides the function of replying to the entire message. However, in some conversation scenarios, a user may want to reply to only some part of the content in a message. In such a case, the function of replying to the entire message will not meet the needs of the user well. For example, when a user receives a message containing a large amount of text sent by another user, it is likely that this user may want to or only need to reply to a part of the text shown in the message, rather than replying to the entire message. For example, FIG. 1A illustrates a PC side conversation interface, which includes a conversation window for displaying conversation messages and an input box for entering the reply content. In this case, the conversation window includes a message 110 received by the user from a current contact, that is, ZHAO Xiaoyan. The message 110 is long, including “I had Mr. Mozart keep me company, It was here, in my mind, and here in my heart, That's beauty of music, They, inmates and warden, can't get that from you, haven't you ever felt that way about music? You need it so we don't forget that there are places in world that aren't made out of stone, that there's something inside that they can't get to, that they can't touch. It's yours.”

At this time, the user may want to reply only to a certain part of the content 112 in the message 110, that is, the text “there's something.”

On the basis of the above observation, the inventor proposes to design a function to reply to a part of the content in a message. A user may use such a function to select a certain part of the content in any message in the conversation window to reply to, which makes the pertinence of the reply message stronger, thereby improving the user experience when multiple users participate in a session communication. Based on the designed reply function, correspondingly, an example embodiment of the present disclosure discloses a method for displaying a reply message. For example, in an example, FIG. 1B shows a reply message 120 displayed according to this displaying method. In this case, the message reference portion 122 includes only the part of the content 112 selected by the user from the message 110, instead of the entire content in the message 110. The reply message 120 also includes the reply content 124 “what?” corresponds to the message reference portion 122, indicated by an arrow 126.

In this way, the multiple users participating in the conversation may quickly locate the part of the content targeted by the reply message, thereby improving the user experience of the users at the same time. The following describes the implementation steps of the foregoing displaying method in combination with the example embodiments.

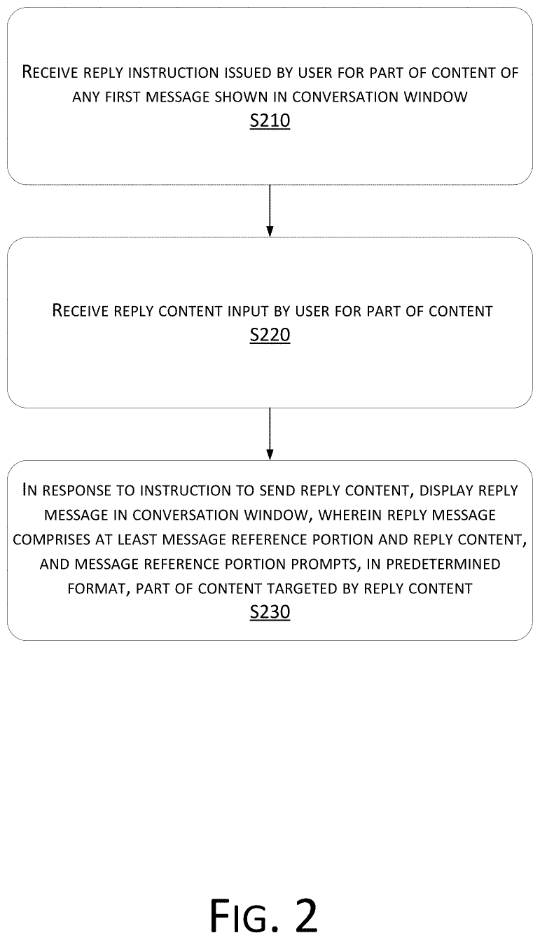

For example, FIG. 2 shows a flowchart of a method for displaying a reply message according to an example embodiment of the present disclosure. The method may be performed by an instant messaging client or a terminal installed with the instant messaging client, such as an instant messaging app, and the like. As shown in FIG. 2, the method includes the following steps: step S210, receiving a reply instruction issued by a user for a part of the content of any first message shown in a conversation window; step S220, receiving a reply content input by the user for the part of the content; and step S230, in response to an instruction to send the reply content, displaying a reply message in the conversation window, wherein the reply message comprises at least a message reference portion and the reply content, and the message reference portion prompts, in a predetermined format, the part of the content targeted by the reply content.

First, step S210 includes receiving a reply instruction issued by a user for a part of the content of any first message shown in a conversation window.

For example, the conversation window includes at least one message, and the first message mentioned above is used to refer to any one of the at least one message. In addition, for example, the first message is a message sent by the user. In such a case, the user's reply to the part of the content in the first message sent by the user may be understood as the user's additional explanation of that part of the content. In another example embodiment, the first message may be a message received from a current contact corresponding to the conversation window. Further, for example, the conversation window may correspond to a private chat, that is, a chat by two users. In such a case, the current contact is the counterpart user of the conversation. In another example embodiment, the conversation window may correspond to a group chat, that is, a chat by three or more users. In such a case, the current contact may be one of the users of the conversation other than this user.

For example, the part of the content mentioned above may be a section of content in the first message corresponding to multiple consecutive characters. In another example embodiment, the aforementioned part of the content may include a plurality of sections of content spaced in the first message.

The first message and the part of the content have been introduced above. Next, the manner of generating the above-mentioned reply instruction will be further described. For example, on the one hand, it may support the user to firstly select the above-mentioned part of the content in the first message, and then issue a reply instruction on the basis of the selected part of the content. On the other hand, it may support the user to firstly select the function of replying to the part of the content of the first message, and then send a reply instruction by means of selecting the part of the content in the first message.

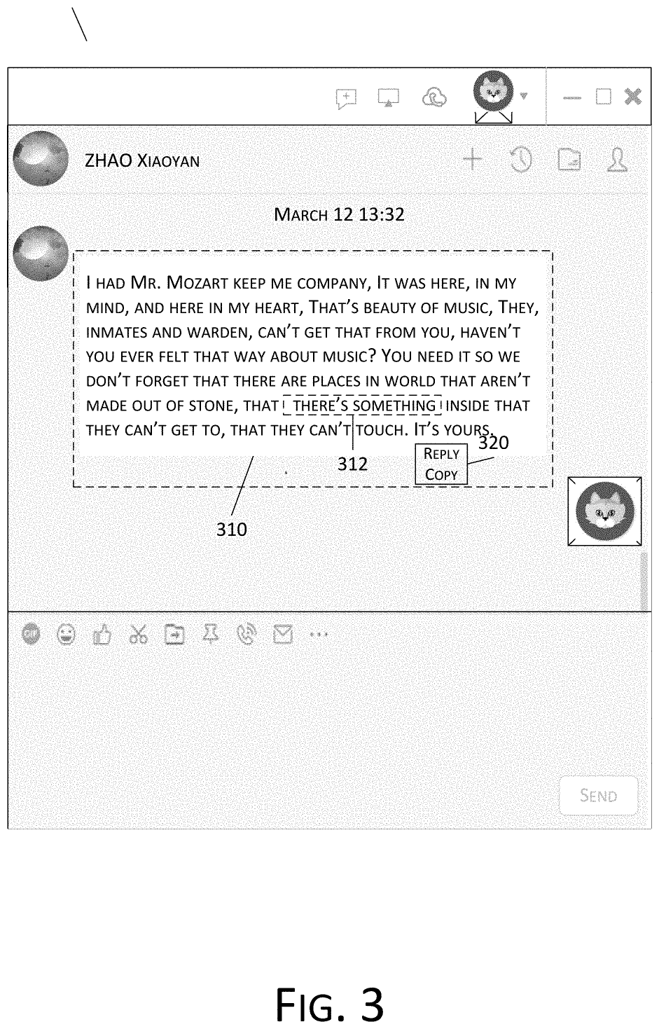

For example, prior to step S210, the method may further include displaying a menu list comprising a reply menu item in response to the user's selection instruction for the part of the content on the basis of the first message. In one example, as shown in FIG. 3, in response to a selection instruction for the part of the content 312 in the message 310, a menu list 320 including a reply menu item and a copy menu item is displayed. Accordingly, step S210 may include: receiving a trigger instruction for the reply menu item. For example, the trigger instruction for the reply menu item may be a click instruction or a voice-activated instruction. In one example, it may correspond to a click operation with the reply menu item shown in FIG. 3.

In another example embodiment, prior to step S210, the method may further include: firstly receiving a user's selection instruction for the part of the content based on the first message, and then in response to a trigger instruction for the selected part of the content, displaying a menu list including a reply menu item. For example, the trigger instruction for the selected part of the content may correspond to an operation of clicking the right button of a mouse. Accordingly, step S210 may include: receiving a trigger instruction for the reply menu item.

In yet another example embodiment, prior to step S210, the method may further include: in response to a trigger instruction for the first message, displaying a menu list comprising a menu item for replying to the part of the content; and then receiving a trigger instruction for the menu item for replying to the part of the content. For example, the trigger instruction for the first message mentioned above may correspond to an operation of moving a cursor to an area where the first message is located. Further, in one example, when the cursor is moved to an area where the first message is located, an icon corresponding to the above menu list including a menu item that responds to part of the content may be displayed. Correspondingly, the trigger instruction for the first message may also correspond to a click operation on the icon. For another example, the trigger instruction for the first message mentioned above may correspond to an operation of clicking the right button of a mouse based on an area where the first message is located. In yet another example, the trigger instruction for the first message mentioned above may correspond to a long-press operation on the area where the first message is located on a touch screen.

On the other hand, for example, the trigger instruction for receiving a menu item that responds to a part of the content may include a click instruction or a voice control instruction. Accordingly, step S210 may include: receiving a selection instruction for the part of the content in the first message. For example, the selection instruction may correspond to the selection instruction for the part of the content. Further, in one example, it may also correspond to a confirmation instruction for the selection instruction.

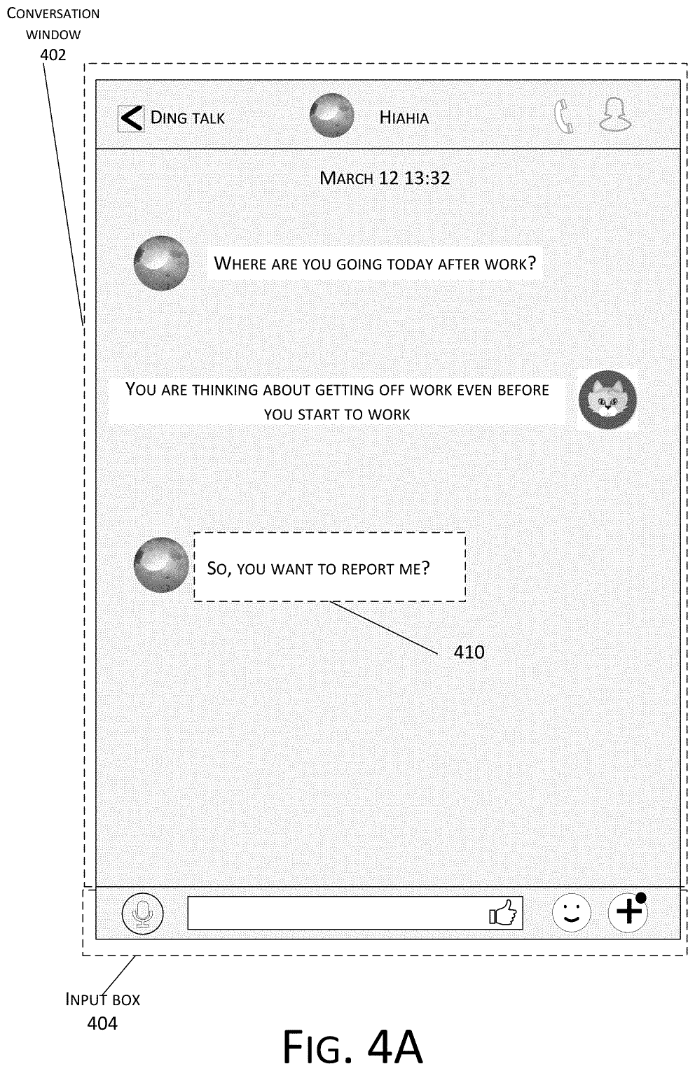

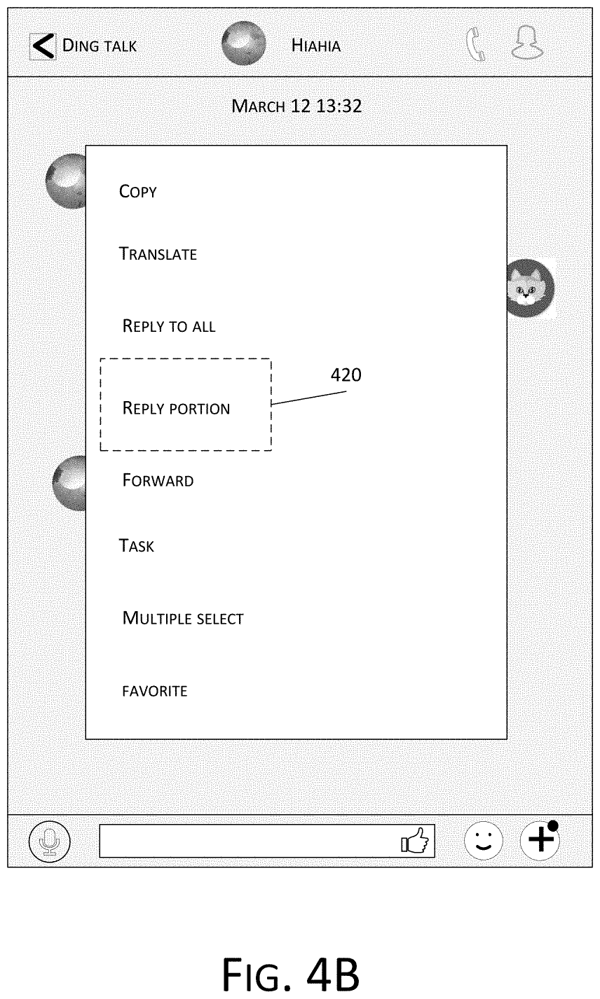

For example, at a conversation window 402 that includes an input box 404, the mobile session interface shown in FIG. 4A and FIG. 4B may, in response to a trigger instruction generated by a long-press operation on the message 410 shown in FIG. 4A, display a menu list including the menu item 420 that responds to the part of the content shown in FIG. 4B. Further, the reply instruction mentioned above may correspond to a click operation with the menu item 420.

According to the above description, it is possible to receive a reply instruction sent by a user for a part of the content in any first message shown in a conversation window. Next, in step S220, a reply content input by the user for the part of the content may be received.

For example, after step S210 and before step S220, the method may further include: displaying prompt information in a conversation interface where the conversation window is located, in which the prompt information may include a message reference portion, and the message reference portion prompts the part of the content targeted by the reply content in a predetermined format. In this way, users may edit the reply content by referring to the prompt information.

Further, for example, the conversation interface may further include an input box.

Accordingly, the step of displaying prompt information in the conversation interface may include: displaying the prompt information above the input box or in the input box. In one example, the prompt information in the non-editable state may be displayed at the upper left corner of the input box.

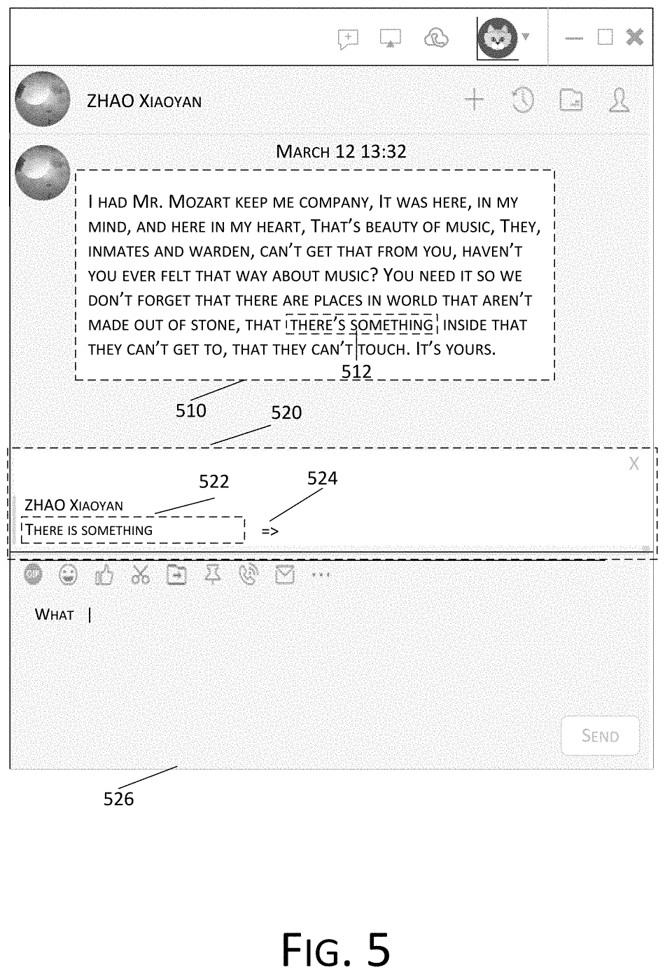

For example, as in the foregoing example embodiment, the part of the content may correspond to a section of content composed of a single character or a plurality of consecutive characters. Accordingly, the message reference portion mentioned above may include only this part of the content. In one example, as shown in FIG. 5,

The conversation window includes a message 510 received by the user from a current contact, that is, ZHAO Xiaoyan. The message 510 is long, including “I had Mr. Mozart keep me company, It was here, in my mind, and here in my heart, That's beauty of music, They, inmates and warden, can't get that from you, haven't you ever felt that way about music? You need it so we don't forget that there are places in world that aren't made out of stone, that there's something inside that they can't get to, that they can't touch. It's yours.”

At this time, the user may want to reply only to a certain part of the content 512 in the message 510, that is, the text “there's something.” The user may select the part of the content 512.

The conversation window displays the prompt information 520, which may be displayed above the input box, in which the message reference portion 522 includes only a section of text 512 in the first message 510. An indication label 524 indicates the reply content to be input for the input box 526. The reply content is “what” as shown in FIG. 5.

In another example embodiment, as in the foregoing example embodiment, the part of the content corresponds to a plurality of sections of content arranged at intervals in the first message. Accordingly, the above-mentioned message reference portion includes a plurality of sections of content identified by the first preset separator. In one example, the first preset separator may be a dash, a space, a single quotation mark, a double quotation mark, a double slash, and so on.

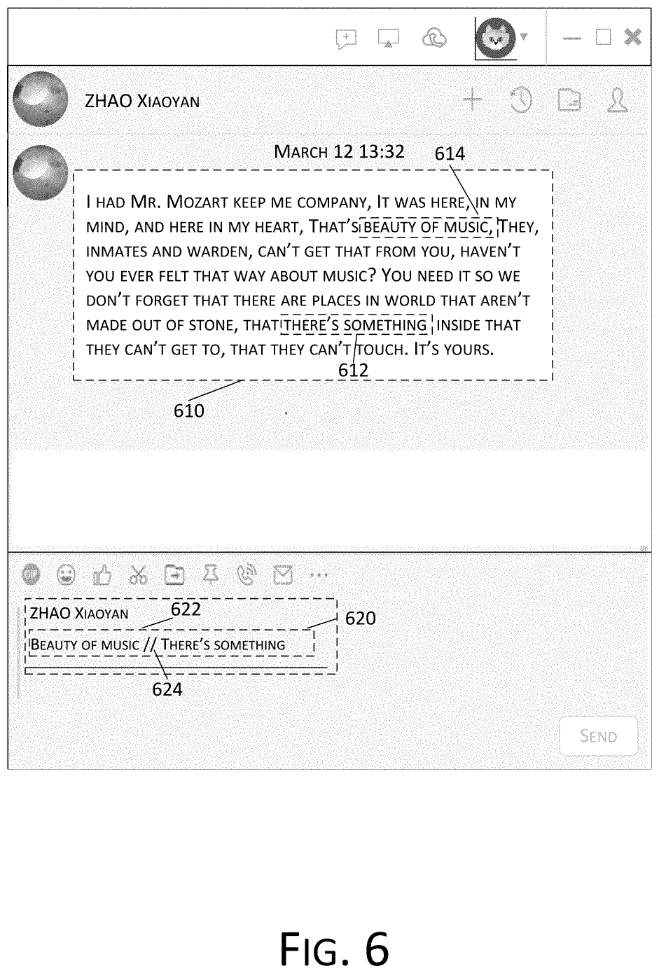

In FIG. 6, the conversation window includes a message 610 received by the user from a current contact, that is, ZHAO Xiaoyan. The message 610 is long, including “I had Mr. Mozart keep me company, It was here, in my mind, and here in my heart, That's beauty of music, They, inmates and warden, can't get that from you, haven't you ever felt that way about music? You need it so we don't forget that there are places in world that aren't made out of stone, that there's something inside that they can't get to, that they can't touch. It's yours.” At this time, the user may want to reply to a plurality of sections in the message 510, that is, the text “beauty of music” 612 and “there's something” 614.

As shown in FIG. 6, prompt information 620 is displayed in the input box, where the message reference portion 622 includes a plurality of sections of content identified by double slashes, where a plurality of sections of content includes text 612 and text 614 in message 610.

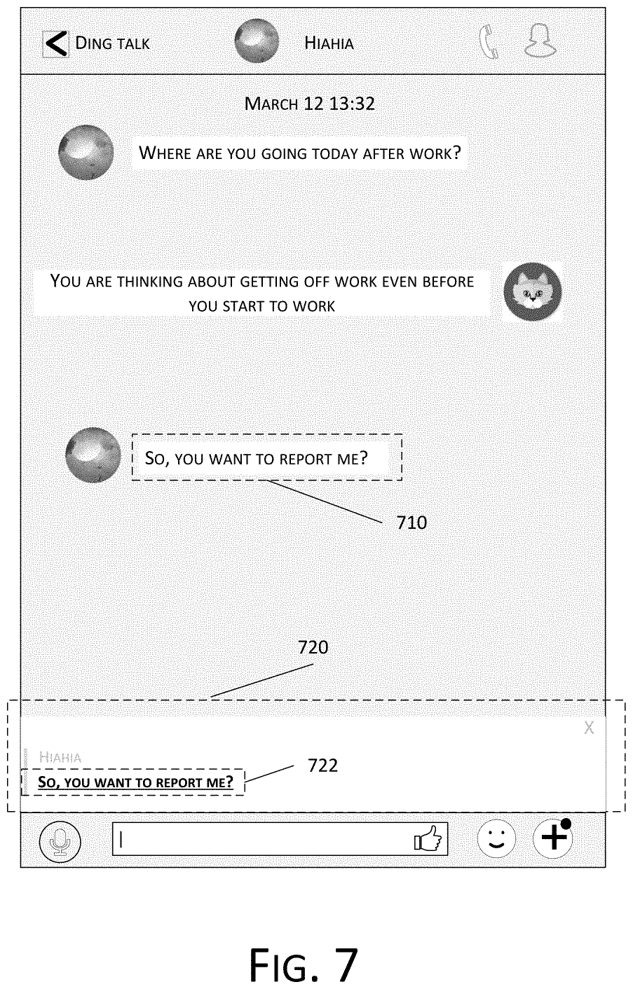

In yet another example embodiment, the above message reference portion includes the message content of the first message, where display with emphasis is on the part of the content. In one example, the display with emphasis includes one or more of a highlighted display, a color changing display, a bolded display and an underlined display. In this way, it may help users quickly locate the part of the content in the message content of the first message, and then better refer to the part of the content of display with emphasis and edit the corresponding reply content. For example, as shown in FIG. 7, a first message 710 “so, you want to report me?” is received from a user or contact. The prompt information 720 is displayed above the input box, and the message reference portion 722 includes the message content of the first message 710, where an underline and a bold display are added to the part of the content.

On the other hand, for example, the prompt information may further include a second preset separator to mark the above message reference portion prompt. For example, in the case where the above-mentioned first preset separator is included in the message reference portion, the first preset separator and the second preset separator are usually set to be different separators. For example, the second preset separator may be a dividing line, an arrow, or the like. In one example, as shown in FIG. 5, the prompt information 520 includes an indication label 524 such as an arrow. In another example, as shown in FIG. 6, the prompt information 620 includes a dividing line 624.

As above, the user may input the reply to the part of the content based on the above prompt information. Accordingly, the reply content input by the user may be received. For example, the user may receive a reply text for the part of the content in the input box, and thus the reply text may be directly used as the reply content. In another example embodiment, a reply voice input by the user for the part of the content may also be received, so that the reply voice may be converted into a reply text, and the converted reply text may be used as reply content. For example, the conversion of the reply voice into the reply text may be implemented by methods in the prior art, and details will not be described herein.

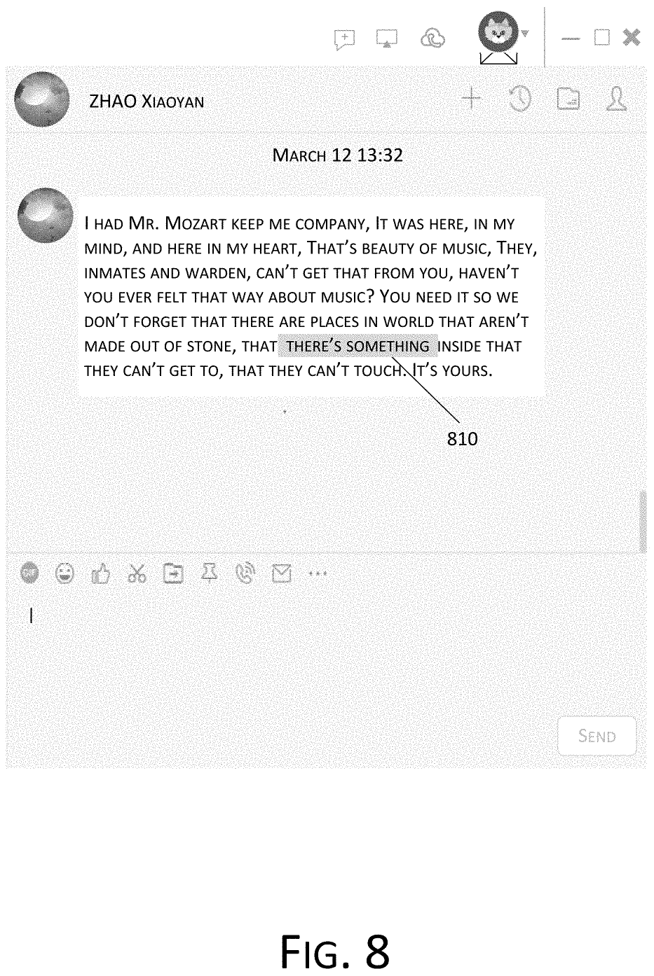

In addition, for example, refer to FIG. 8, in response to the above-mentioned reply instruction, the input box automatically obtains focus for the selected part of the content 810 “there's something”, and the user may input reply content in the input box.

Through the above-mentioned manner, the reply content entered by the user may be received. Then, in step S230, in response to the instruction for sending the reply content, a reply message is displayed in the conversation window, the reply message includes at least a message reference portion and the reply content, and the message reference portion prompts the part of the content targeted by the reply content in a predetermined format.

For example, the sending instruction may be a click instruction or a voice control instruction. For example, the click instruction corresponds to a click operation on the sending icon.

For example, the introduction of the message reference portion in the preset separator may refer to the related description in the foregoing example embodiment, and details are not described herein.

For example, the above reply message may further include a second preset separator for separating the message reference portion and the reply content. For example, for the introduction of the second preset separator, reference may also be made to the description in the foregoing example embodiment.

Further, for example, the message reference portion, the second preset separator and the reply content may be combined in an order of from left to right to form the reply message. In one example, FIG. 1B shows the conversation interface based on FIG. 5, which includes a reply message 120 composed of a message reference portion 122, an arrow 126 and the reply content 124 in an order of from left to right.

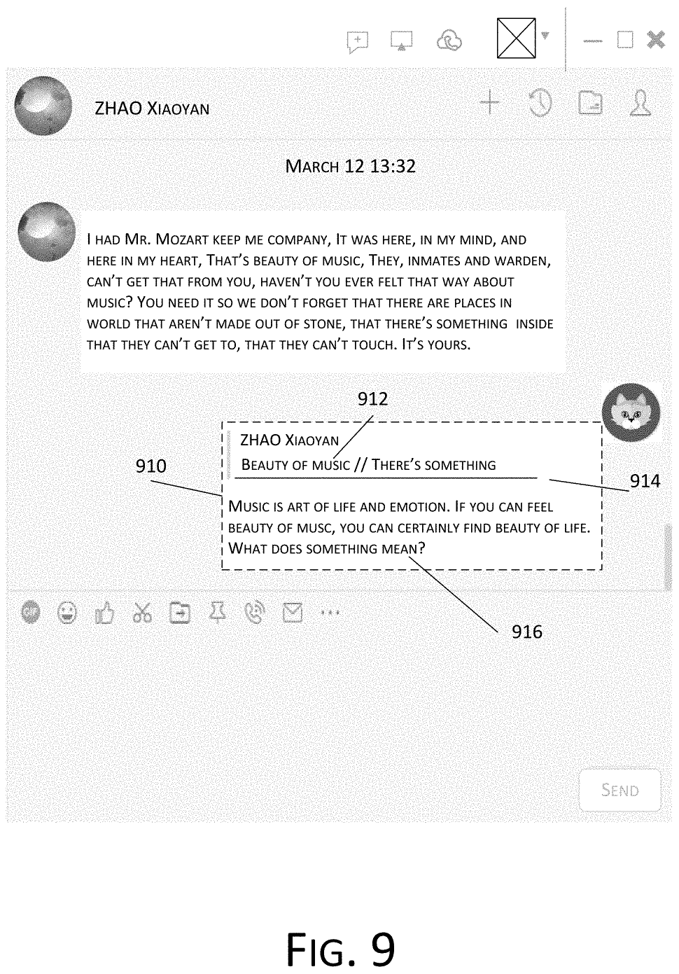

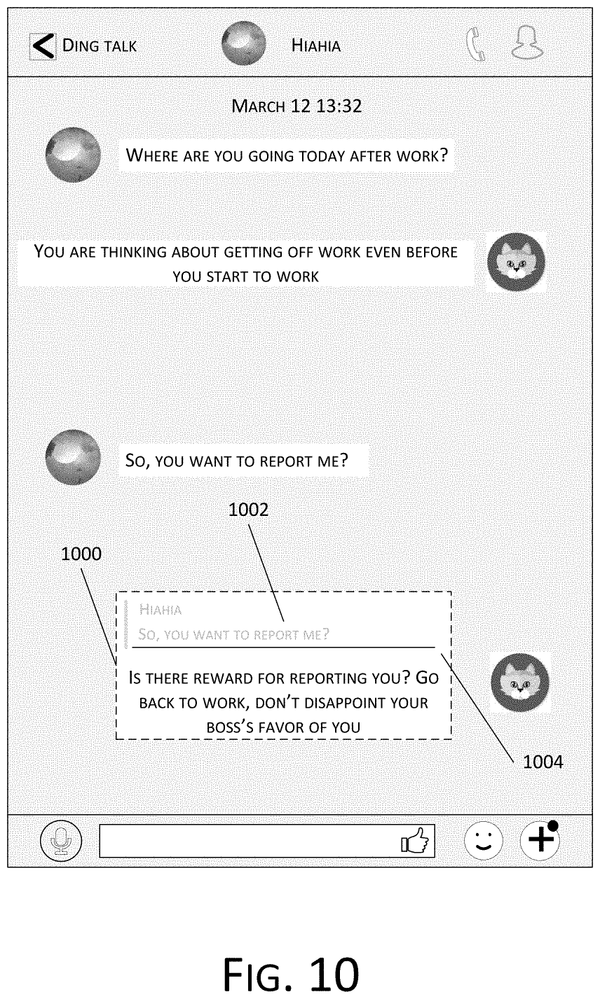

In another example embodiment, the message reference portion, the second preset separator and the reply content may be combined in an order of from top to bottom to form the reply message. In one example, FIG. 9 shows the conversation interface based on FIG. 6, which includes a reply message 910 composed of a message reference portion 912, a divider 914 and the reply content 916 in an order of from top to bottom. In another example, FIG. 10 illustrates a conversation interface based on FIG. 7, which includes a reply message 1000 that is below a message reference portion 1002 and a divider 1004.

As shown above, the reply message that replies to the part of the content in the first message may be displayed in the conversation window.

It may be understood that the prompt information may further include a sender name corresponding to the first message. In addition, the reply message may further include a sender name corresponding to the first message and a sender name corresponding to the reply message.

As may be seen from the above, the method for displaying a reply message provided in the example embodiments of the present disclosure enables a user to select a part of the content in any message shown in the conversation window to reply to, so that the pertinence of the reply message is stronger, thereby improving the user experience when multiple users participate in a session communication.

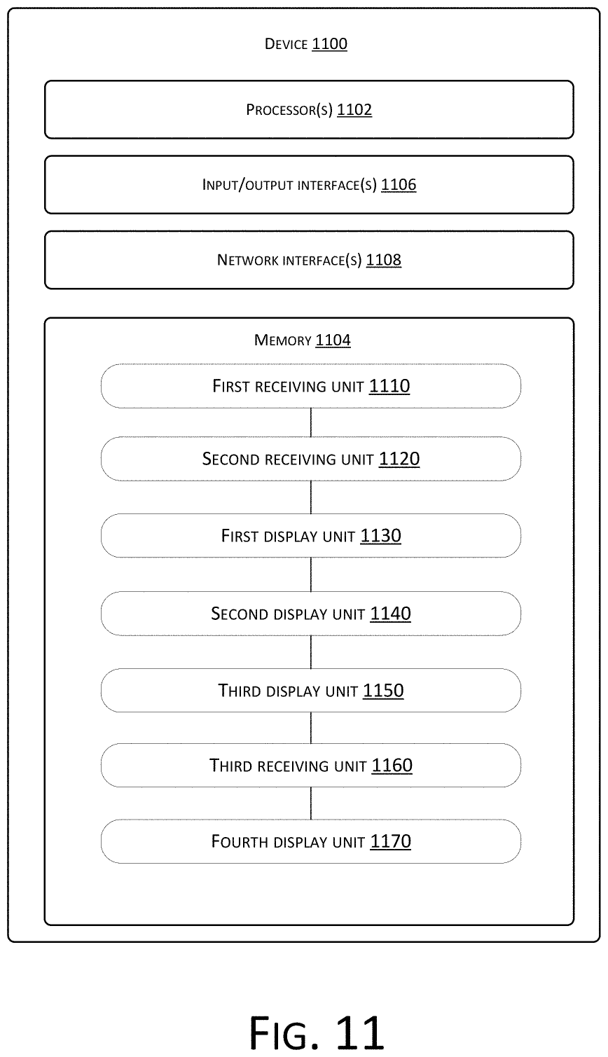

According to an example embodiment, a displaying device is also provided, and the device may be integrated in an instant messaging client. FIG. 11 is a structural diagram of a device for displaying a reply message according to an example embodiment. As shown in FIG. 11, the device 1100 includes one or more processor(s) 1102 or data processing unit(s) and memory 1104. The device 1100 may further include one or more input/output interface(s) 1106 and one or more network interface(s) 1108.

The memory 1104 is an example of computer readable storage media.

Computer readable storage medium or media include both permanent and non-permanent, removable and non-removable media, may store, by any method or technology, information. The information may be computer readable instructions, data structures, modules of programs, or other data. Examples of computer readable storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer readable storage media do not include transitory media such as modulated data signals and carriers.

The memory 1104 may store therein a plurality of the following modules or units including a first receiving unit 1110, which is configured to receive a reply instruction issued by a user for a part of the content of any first message shown in a conversation window; a second receiving unit 1120, which is configured to receive a reply content input by the user for the part of the content; and a first display unit 1130, which is configured to, in response to an instruction to send the reply content, display a reply message in the conversation window, wherein the reply message comprises at least a message reference portion and the reply content, and the message reference portion prompts, in a predetermined format, the part of the content targeted by the reply content.

For example, the first message is a message sent by the user. It is a message received from a current contact corresponding to the conversation window.

For example, the device 1100 may further include the following unit stored in the memory 1104: a second display unit 1140, which is configured to display a menu list including a reply menu item in response to a user's selection instruction for the part of the content based on the first message; in addition, the first receiving unit 1110 is configured to receive a trigger instruction for the reply menu item.

For example, the device 1100 may further include the following units stored in the memory 1104: a third display unit 1150, which is configured to display a menu list including a menu item that responds to a part of the content in response to a trigger instruction to the first message; and a third receiving unit 1160, which is configured to receive a trigger instruction of the menu item that responds to the part of the content; in this case, the first receiving unit 1110 is configured to receive a selection instruction for the part of the content in the first message.

For example, the device 1100 may further include the following unit stored in the memory 1104: a fourth display unit 1170, which is configured to display prompt information in a conversation interface where the conversation window is located, where the prompt information includes the message reference portion.

Further, for example, the conversation interface includes an input box, and the third display unit 1170 is configured as follows.

The prompt information may be displayed above the input box or in the input box.

For example, the message reference portion includes only the part of the content.

For example, the part of the content may correspond to a plurality of sections of content in the first message. The message reference portion includes the plurality of sections of content separated by a first preset separator.

For example, the message reference portion includes the message content of the first message, while the part of the content is displayed with emphasis.

Further, for example, the display with emphasis may include at least one of a highlighted display, a color changing display, a bolded display and an underlined display.

For example, the reply message further includes a second preset separator for separating the message reference portion from the reply content.

Further, for example, the message reference portion, the second preset separator and the reply content are combined in an order of from left to right to form the reply message; alternatively, the message reference portion, the second preset separator and the reply content may be combined into the reply message in an order of from top to bottom.

As described above, according to an example embodiment, a computer readable storage medium may be further provided, in which a computer program is stored, and when the computer program is executed by the computer, the computer is caused to execute the method shown in FIG. 2.

According to an example embodiment, a computing device is further provided, which may include a memory and a processor, where the memory stores computer-executable instructions, and when the processor executes the computer-executable instructions, the method shown in FIG. 2 may be implemented.

A person skilled in the art may appreciate that in one or more of the above examples, the functions described in the example embodiments disclosed in the present disclosure may be implemented by hardware, software, firmware, or any combination thereof. When implemented by software, the functions may be stored in a computer readable medium or transmitted as one or more computer-readable instructions or code stored in computer readable storage media.

In the example embodiments described above, the purposes, technical solutions, and beneficial effects of the multiple example embodiments disclosed in the present disclosure have been further described in detail. It should be understood that the above descriptions are only certain examples of the embodiments disclosed in the present disclosure, which are not intended to limit the scope of protection of the multiple example embodiments disclosed in the present disclosure. Any modification, equivalent replacement, or improvement made on the basis of the technical solutions of the multiple example embodiments disclosed in the present disclosure shall be encompassed within the scope of protection of the multiple example embodiments disclosed in the present disclosure.

The present disclosure may further be understood with clauses as follows.

Clause 1. A method for displaying a reply message, wherein the method is executed by an instant messaging client, the method comprising:

receiving a reply instruction issued by a user for a part of the content of a first message shown in a conversation window;

receiving a reply content input by the user for the part of the content; and

in response to an instruction to send the reply content, displaying a reply message in the conversation window, the reply message including at least a message reference portion and the reply content, the message reference portion prompting, in a predetermined format, the part of the content targeted by the reply content.

Clause 2. The method according to clause 1, wherein the first message is a message received from a current contact corresponding to the conversation window.

Clause 3. The method according to clause 1, wherein:

prior to the receiving the reply instruction issued by the user for the part of the content of the first message shown in the conversation window, the method further comprises displaying a menu list including a reply menu item in response to the user's selection instruction for the part of the content on the basis of the first message; and

the receiving the reply instruction issued by the user for the part of the content of the first message shown in the conversation window comprises receiving a trigger instruction for the reply menu item.

Clause 4. The method according to clause 1, wherein:

prior to the receiving the reply instruction issued by the user for the part of the content of any first message shown in the conversation window, the method further comprises:
in response to a trigger instruction for the first message, displaying a menu list including a menu item for replying to the part of the content; and
receiving a trigger instruction for the menu item for replying to the part of the content;

the receiving the reply instruction issued by the user for the part of the content of the first message shown in the conversation window comprises receiving a selection instruction for the part of the content in the first message.

Clause 5. The method according to clause 1, wherein prior to the receiving the reply content input by the user for the part of the content, the method further comprises:

displaying prompt information in a conversation interface where the conversation window is located, the prompt information including the message reference portion.

Clause 6. The method according to clause 5, wherein:

the conversation interface comprises an input box; and

the displaying the prompt information in the conversation interface where the conversation window is located comprises displaying the prompt information above the input box or in the input box.

Clause 7. The method according to clause 1, wherein the message reference portion includes only the part of the content.

Clause 8. The method according to clause 1, wherein:

the part of the content corresponds to a plurality of sections of content in the first message; and

the message reference portion comprises the plurality of sections of content separated and identified by a first preset separator.

Clause 9. The method according to clause 1, wherein:

the message reference portion comprises the message content of the first message; and

the method further comprises displaying the part of the content via a display with emphasis.

Clause 10. The method according to clause 9, wherein the display with emphasis comprises at least one selected from a group including:

a highlighted display;

a color changing display;

a bolded display; and

an underlined display.

Clause 11. The method according to clause 1, wherein the reply message further comprises a second preset separator for separating the message reference portion from the reply content.

Clause 12. The method according to clause 11, wherein:

the message reference portion, the second preset separator and the reply content are combined into the reply message in an order of from left to right; or

the message reference portion, the second preset separator and the reply content are combined into the reply message in an order of from top to bottom.

Clause 13. A method for displaying a message, wherein the method is executed by an instant messaging client, the method comprising:

receiving a reply instruction issued by a user for a part of the content of a first message shown in a conversation window, the first message being a message sent by the user;

receiving a reply content input by the user for the part of the content; and

in response to an instruction to send the reply content, displaying a reply message in the conversation window, the reply message including at least a message reference portion and the reply content, the message reference portion prompting, in a predetermined format, the part of the content targeted by the reply content.

Clause 14. The method according to clause 13, wherein prior to the receiving the reply content input by the user for the part of the content, the method further comprises displaying prompt information in a conversation interface where the conversation window is located, the prompt information including the message reference portion.

Clause 15. The method according to clause 13, wherein the message reference portion includes only the part of the content.

Clause 16. The method according to clause 13, wherein the reply message further comprises a second preset separator for separating the message reference portion from the reply content.

Clause 17. An instant messaging client comprising:

a display area for displaying a reply message generated in response to a sending instruction for a reply content in a conversation window, the reply content being input by a user for a part of the content in a first message shown in the conversation window, the reply message including at least the reply content and a message reference portion, the message reference portion prompting, in a predetermined format, the part of the content targeted by the reply content.

Clause 18. A device for displaying a reply message, wherein the device is integrated with an instant messaging client, the device comprising:

a first receiving unit configured to receive a reply instruction issued by a user for a part of the content of a first message shown in a conversation window;

a second receiving unit configured to receive a reply content input by the user for the part of the content; and

a display unit configured to, in response to an instruction to send the reply content, display a reply message in the conversation window, the reply message including at least a message reference portion and the reply content, the message reference portion prompting, in a predetermined format, the part of the content targeted by the reply content.

Clause 19. A computer readable storage medium having stored thereon a computer program that, when executed by a computer, causes the computer to execute the method according to any one of claims 1 to 16.

Clause 20. A computing device comprising one or more memories and one or more processors, the one or more memories storing computer-executable instructions that, when executed by the one or more processors, cause the one or more processors to implement the method according to any one of claims 1 to 16.

What is claimed is:

1. A method comprising:
receiving a reply instruction issued by a user for a part of the content of a first message shown in a conversation window;
receiving a reply content input by the user for the part of the content; and
in response to an instruction to send the reply content, displaying a reply message in the conversation window, the reply message including at least a message reference portion and the reply content, the message reference portion prompting, in a predetermined format, the part of the content targeted by the reply content.

2. The method according to claim 1, wherein the first message is a message received from a current contact corresponding to the conversation window.

3. The method according to claim 1, wherein:
prior to the receiving the reply instruction issued by the user for the part of the content of the first message shown in the conversation window, the method further comprises displaying a menu list including a reply menu item in response to the user's selection instruction for the part of the content on the basis of the first message; and
the receiving the reply instruction issued by the user for the part of the content of the first message shown in the conversation window comprises receiving a trigger instruction for the reply menu item.

4. The method according to claim 1, wherein:
prior to the receiving the reply instruction issued by the user for the part of the content of any first message shown in the conversation window, the method further comprises:
in response to a trigger instruction for the first message, displaying a menu list including a menu item for replying to the part of the content; and
receiving a trigger instruction for the menu item for replying to the part of the content; and
the receiving the reply instruction issued by the user for the part of the content of the first message shown in the conversation window comprises receiving a selection instruction for the part of the content in the first message.

5. The method according to claim 1, wherein prior to the receiving the reply content input by the user for the part of the content, the method further comprises:
displaying prompt information in a conversation interface where the conversation window is located, the prompt information including the message reference portion.

6. The method according to claim 5, wherein:
the conversation interface comprises an input box; and
the displaying the prompt information in the conversation interface where the conversation window is located comprises displaying the prompt information above the input box or in the input box.

7. The method according to claim 1, wherein the message reference portion includes the part of the content.

8. The method according to claim 1, wherein:
the part of the content corresponds to a plurality of sections of content in the first message; and
the message reference portion comprises the plurality of sections of content separated and identified by a first preset separator.

9. The method according to claim 1, wherein:
the message reference portion comprises the message content of the first message; and
the method further comprises displaying the part of the content via a display with emphasis.

10. The method according to claim 9, wherein the display with emphasis comprises at least one selected from a group including:
a highlighted display;
a color changing display;
a bolded display; and
an underlined display.

11. The method according to claim 1, wherein the reply message further comprises a second preset separator for separating the message reference portion from the reply content.

12. The method according to claim 11, further comprising combining the message reference portion, the second preset separator and the reply content into the reply message in an order of from left to right.

13. The method according to claim 11, further comprising combining the message reference portion, the second preset separator and the reply content into the reply message in an order of from top to bottom.

14. A device comprising:
one or more processors; and
one or more memories storing computer-readable instructions that, executable by the one or more processors, cause the one or more processors to perform acts comprising:
receiving a reply instruction issued by a user for a part of the content of a first message shown in a conversation window, the first message being a message sent by the user;
receiving a reply content input by the user for the part of the content; and
in response to an instruction to send the reply content, displaying a reply message in the conversation window, the reply message including at least a message reference portion and the reply content, the message reference portion prompting, in a predetermined format, the part of the content targeted by the reply content.

15. The device according to claim 14, wherein prior to the receiving the reply content input by the user for the part of the content, the method further comprises displaying prompt information in a conversation interface where the conversation window is located, the prompt information including the message reference portion.

16. The device according to clause 14, wherein the message reference portion includes the part of the content.

17. The device according to claim 14, wherein
the part of the content corresponds to a plurality of sections of content in the first message; and
the message reference portion comprises the plurality of sections of content separated and identified by a first preset separator.

18. The device according to claim 14, wherein the reply message further comprises a second preset separator for separating the message reference portion from the reply content.

19. One or more memories storing computer-readable instructions that, executable by one or more processors, cause the one or more processors to perform acts comprising:
displaying a reply message generated in response to a sending instruction for a reply content in a conversation window, the reply content being a part of the content in a first message shown in the conversation window, the reply message including at least the reply content and a message reference portion, the message reference portion prompting, in a predetermined format, the part of the content targeted by the reply content.

20. The one or more memories according to claim 19, wherein the message reference portion includes the part of the content.
